(19) United States
(12) Patent Application Publication
(10) Pub. No.: US 2016/0010843 A1
(43) Pub. Date: Jan. 14, 2016

(54) PRE-COATED ALUMINUM SHEET, ALUMINUM SHEET, AND HEAT SINK FOR ONBOARD LED LIGHTING

(71) Applicant: KABUSHIKI KAISHA KOBE SEIKO SHO (KOBE STEEL, LTD.), Kobe-shi (JP)

(72) Inventors: Nobuo HATTORI, Moka-shi (JP); Haruyuki KONISHI, Kobe-shi (JP); Kazunori KOBAYASHI, Moka-shi (JP); Daisuke KANEDA, Moka-shi (JP)

(73) Assignee: KABUSHIKI KAISHA KOBE SEIKO SHO (KOBE STEEL, LTD.), Kobe-shi (JP)

(21) Appl. No.: 14/772,553

(22) PCT Filed: Mar. 27, 2014
(86) PCT No.: PCT/JP14/59041

§ 371 Date: Sep. 3, 2015

(30) Foreign Application Priority Data
Mar. 29, 2013 (JP) 2013-073265
Mar. 29, 2013 (JP) 2013-073267

(51) Int. Cl. F21V 29/89; C09D 163/00; C22C 21/00; C09D 167/00

(52) U.S. Cl. CPC F21V 29/89; C09D 167/00; C09D 163/00; C22C 21/00

(57) ABSTRACT

A pre-coated aluminum sheet, an aluminum sheet, and a heat sink for onboard LED lighting excellent in the heat radiation property are provided. The pre-coated aluminum sheet is used for the heat sink for onboard LED lighting, and is the pre-coated aluminum sheet including an aluminum sheet and a resin-based film. The thermal conductivity of the aluminum sheet is equal to or greater than 150 W/m·K, the resin-based film includes a thermosetting resin and a black pigment composition, and the integrated emissivity of the resin-based film in the infrared region having the wavelength of 3-30 μm is equal to or greater than 0.80 at 25° C.

### TECHNICAL FIELD

The present invention relates to a pre-coated aluminum sheet for a heat sink for onboard LED lighting for mounting a light emission diode (LED) element thereon, an aluminum sheet, and a heat sink for onboard LED lighting.

### BACKGROUND ART

The lighting having a light emission diode (LED) element as a light emission source has started to penetrate the market gradually because of low power consumption and long life. Among the lighting, the onboard LED lighting such as a headlight of an automobile has especially got a lot of attention in recent years.

However, the LED element that is a light emission source of this LED lighting is very sensitive to heat, and has the problem that the light emission efficiency drops and the life thereof is affected when the temperature exceeds a permissible limit. In order to solve this problem, the heat in light emission of the LED element should be radiated to the surrounding space, and therefore a large heat sink is provided in the LED lighting.

For this heat sink for LED lighting, those made of an aluminum die-cast whose material is aluminum (including aluminum alloy) are commonly employed, and the heat sinks having typical configurations out of these heat sinks are disclosed in Patent Literatures 1-4.

### CITATION LIST

### Patent Literatures

[Patent Literature 1] Japanese Unexamined Patent Application Publication No. 2007-172932

[Patent Literature 2] Japanese Unexamined Patent Application Publication No. 2007-193960

[Patent Literature 3] Japanese Unexamined Patent Application Publication No. 2009-277535

[Patent Literature 4] Japanese Unexamined Patent Application Publication No. 2010-278350

### SUMMARY OF INVENTION

### Technical Problems

In recent years, outputting a high power has been progressing with respect to the onboard LED lighting, and further improvement of the heat radiation property is required for the heat sink for onboard LED lighting.

On the other hand, the heat sink for onboard LED lighting is shifting to a formed body obtained by forming work of an aluminum sheet instead of an aluminum die-cast of a prior art in order to improve the productivity and to reduce the cost.

Therefore, with respect to the heat sink formed of a formed body of the aluminum sheet, the needs for further improvement of the heat radiation property from the property of the aluminum sheet itself forming the heat sink and the surface of the sheet have been strengthened in order to improve the heat radiation property.

Also, such a problem has been newly raised that, because the formability is inferior, when bending work and the like is performed for the aluminum sheet, surface roughening occurs in the worked part, the shape becomes non-uniform locally, and sufficient heat radiation property cannot be secured.

The present invention has been developed in order to solve the problems described above, and its object is to provide a pre-coated aluminum sheet and a heat sink for onboard LED lighting excellent in the heat radiation property. Further, to provide a pre-coated aluminum sheet, an aluminum sheet, and a heat sink for onboard LED lighting excellent in the smoothness of the surface of the worked part is the object.

### Solution to Problems

In order to solve the problems described above, as a result of proceeding the study, such knowledge has been obtained that it is important to make the thermal conductivity of the aluminum sheet a constant level or higher in order to reduce the heat resistance of the raw material, to increase the emissivity by forming a black film on the surface of the formed body formed of the aluminum sheet, to comparatively reduce the thickness of the film and to reduce the heat resistance as the film, and to properly control the surface roughness of the film and to increase the emissivity, and so on, and the present invention has been achieved.

The present invention has such a configuration as described below. The pre-coated aluminum sheet related to the first invention is characterized to be used for a heat sink for onboard LED lighting and to include an aluminum sheet and a resin-based film, in which the thermal conductivity of the aluminum sheet is equal to or greater than 150 W/m·K, the crystal microstructure of the aluminum sheet is fibrous, the resin-based film includes a thermosetting resin and a black pigment composition, and the integrated emissivity in the infrared region having the wavelength of 3-30 μm is equal to or greater than 0.80 at 25° C.

According to such a configuration, the color tone of the heat sink becomes black, the durability of the resin film improves, a formed body with less surface roughening can be manufactured, and the cracking is hardly generated in the coating film in bending work of the pre-coated aluminum sheet. Also, more excellent heat radiation property of the aluminum sheet is secured.

The pre-coated aluminum sheet related to the second invention is characterized to be used for a heat sink for onboard LED lighting and to include an aluminum sheet and a resin-based film, in which the thermal conductivity of the aluminum sheet is equal to or greater than 150 W/m·K, the resin-based film includes a thermosetting resin, a black pigment composition, and aggregate, the film thickness of the resin-based film is 5-15 μm, the arithmetic mean roughness Ra of the surface of the resin-based film is 1-3 μm, and the integrated emissivity of the resin-based film in the infrared region having the wavelength of 3-30 μm is equal to or greater than 0.80 at 25° C.

According to such a configuration, the pre-coated aluminum sheet has excellent thermal conductivity of the aluminum sheet, has excellent radiation property as a film although the film is comparatively thin, and comes to have excellent heat radiation property when it is made a heat sink.

Also, it is preferable that, in the pre-coated aluminum sheet related to the second invention, the crystal microstructure of the aluminum sheet is fibrous.

According to such a configuration, a formed body with less surface roughening can be manufactured in forming work.

Also, the aluminum sheet related to the second invention is characterized to be used for a heat sink for onboard LED lighting, in which the thermal conductivity is equal to or greater than 150 W/m·K, and the crystal microstructure is fibrous.

According to such a configuration, a formed body with less surface roughening can be manufactured in forming work, and excellent heat radiation property of the aluminum sheet is secured.

The heat sink for onboard LED lighting (hereinafter referred to as a heat sink when it is appropriate) related to the first invention is characterized to be a heat sink for onboard LED lighting composed of a formed body formed of wrought aluminum and aluminum alloy sheets, in which the thermal conductivity of the wrought aluminum and aluminum alloy sheets is equal to or greater than 150 W/m·K, and the arithmetic mean roughness Ra of the surface of the worked part of the formed body is equal to or less than 1.5 μm.

According to such a configuration, the heat sink is excellent in smoothness of the surface of the worked part, the thermal conductivity of the wrought aluminum and aluminum alloy sheets is equal to or greater than 150 W/m·K, and thereby excellent heat radiation property is secured.

Also, it is preferable that the crystal microstructure of the wrought aluminum and aluminum alloy sheets forming the heat sink for onboard LED lighting related to the first invention is fibrous.

According to such a configuration, a formed body with less surface roughening can be manufactured in forming work.

Also, it is preferable that the surface of the formed body of the heat sink for onboard LED lighting related to the first invention includes a black film, and that the integrated emissivity of the film in the infrared region having the wavelength of 3-30 μm is equal to or greater than 0.80 at 25° C.

According to such a configuration, the color tone of the heat sink becomes black, and the heat radiation property as a heat sink becomes more excellent.

Also, it is preferable that the film on the surface of the formed body of the heat sink for onboard LED lighting related to the first invention is a resin-based film including a thermosetting resin and a black pigment composition. According to such a configuration, the durability of the resin film improves.

The heat sink for onboard LED lighting related to the second invention is characterized to be a heat sink for onboard LED lighting including a heat sink formed body formed of wrought aluminum and aluminum alloy sheets and a black film formed on the surface of the heat sink formed body, in which the thermal conductivity of the wrought aluminum and aluminum alloy sheets is equal to or greater than 150 W/m·K, the film thickness of the film is 5-15 μm, the arithmetic mean roughness Ra of the surface of the film is 0.5-3 μm, and the integrated emissivity of the film in the infrared region having the wavelength of 3-30 μm is equal to or greater than 0.80 at 25° C.

According to such a configuration, the heat sink has excellent thermal conductivity of the wrought aluminum and aluminum alloy sheets and has excellent radiation property as a film although the film is comparatively thin, and excellent heat radiation property is secured as a heat sink.

Also, it is preferable that the film of the heat sink related to the second invention is a resin-based film including a thermosetting resin, a black pigment composition, and aggregate and the arithmetic mean roughness Ra of the surface of the film is 1-3 μm.

According to such a configuration, the durability of the resin film improves, and the radiation property as the film becomes more excellent.

### Advantageous Effects of Invention

The aluminum sheet and the pre-coated aluminum sheet of the present invention are excellent in formability, and can obtain a heat sink for onboard LED lighting having smooth surface of the worked part and excellent in the heat radiation property. Also, the pre-coated aluminum sheet of the second invention can obtain a heat sink for onboard LED lighting excellent in the heat radiation property. Further, the heat sink for onboard LED lighting of the first invention is excellent in the smoothness of the surface of the worked part, and is excellent in the heat radiation property. Furthermore, the heat sink for onboard LED lighting of the second invention is excellent the heat radiation property.

### BRIEF DESCRIPTION OF DRAWINGS

FIG. 1A is a cross-sectional view schematically showing a configuration of the heat sink for onboard LED lighting related to the present invention.

FIG. 1B is a cross-sectional view schematically showing a configuration of the pre-coated aluminum sheet of the present invention.

### DESCRIPTION OF EMBODIMENTS

Below, embodiments of the present invention will be explained referring to the drawings. Also, the content explained as the present invention without particularly mentioning the first invention or the second invention is the content common to the first invention and the second invention.

### <<Heat Sink>>

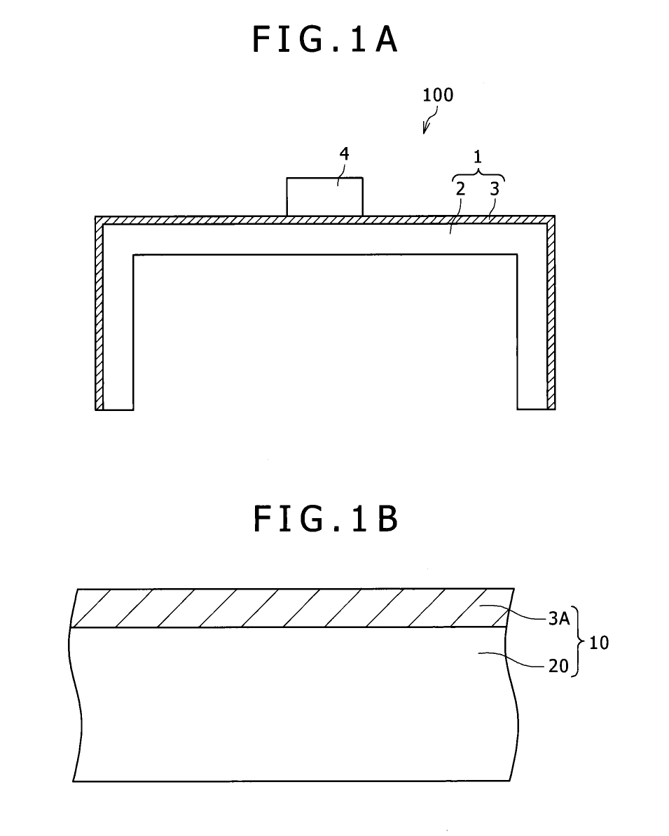

As illustrated in FIG. 1A, a heat sink 1 related to the present invention is used for an onboard LED lighting 100, and is formed of a heat sink formed body 2 formed of wrought aluminum and aluminum alloy sheets. According to some embodiments of the invention, a film 3 formed on the surface of the heat sink formed body 2 is included. Also, the heat sink 1 is used for emitting the heat generated from an LED element 4.

Below, each configuration will be explained.

### <Heat Sink Formed Body>

The heat sink formed body 2 is one formed of wrought aluminum and aluminum alloy sheets and is made of an aluminum. The reason of specifying “wrought aluminum and aluminum alloy sheets” is to discriminate it against those made of an aluminum die-cast, extruded material, resin, iron and other metals currently in use by limitation to the wrought aluminum and aluminum alloy sheets. An aluminum sheet excellent in the productivity, pre-coating treatability and the like is preferable among wrought aluminum and aluminum alloy sheets. Below, the aluminum sheet will be explained.

### [Raw Material of Aluminum Sheet]

The aluminum sheet mentioned used for the heat sink 1 for onboard LED lighting of the present invention is formed of aluminum or aluminum alloy, and the aluminum sheet (aluminum sheet or aluminum alloy sheet) used in the present invention is not particularly limited, and can be selected based on the product shape, forming method, strength required at the time of use, and the like. In general, as an aluminum sheet for press forming, a non-heat treatment type aluminum sheet that is 1000 series pure aluminum sheet for industrial use, 3000 series Al—Mn system alloy sheet, and 5000 series Al—Mg system alloy sheet, or a part of 6000 series Al—Mg—Si system alloy sheet which is a heat treatment type aluminum sheet are used. However, with respect to the heat sink formed body 2, because the thermal conductivity is made equal to or greater than 150 W/m·K as described below, the aluminum sheet is generally limited to 1000 series, a part of 3000 series, and a part of 6000 series.

The aluminum sheet used for the heat sink 1 for onboard LED lighting of the present invention is preferably 1000 series, and especially preferable composition is as follows.

### [Preferable Range of Si Content: 0.03-1.00 Mass %]

Si has an effect of being solid-solutionized in the base metal and increasing the strength of an aluminum alloy sheet, and the effect thereof improves as Si content increases. The effect thereof becomes more sufficient when Si content is equal to or greater than 0.03 mass %, and the thermal conductivity improves and the performance as a heat sink material improves when Si content is equal to or less than 1.00 mass %.

### [Preferable Range of Fe Content: 0.10-0.80 Mass %]

Fe has an effect of being solid-solutionized in the base metal and increasing the strength of an aluminum alloy sheet, and the effect thereof improves as Fe content increases. The effect thereof becomes more sufficient when Fe content is equal to or greater than 0.10 mass %, and the thermal conductivity improves and the performance as a heat sink material improves when Fe content is equal to or less than 0.80 mass %.

[Preferable Range of Cu Content: Equal to or Less than 0.30 Mass %]

Cu has an effect of being solid-solutionized in the base metal and increasing the strength of an aluminum alloy sheet, and the effect thereof improves as Cu content increases. The thermal conductivity improves and the performance as a heat sink material improves when Cu content is equal to or less than 0.30 mass %.

[Preferable Range of Mn Content: Equal to or Less than 0.20 Mass %]

Mn has an effect of being solid-solutionized in the base metal and increasing the strength of an aluminum alloy sheet, and the effect thereof improves as Mn content increases. The thermal conductivity improves and the performance as a heat sink material improves when Mn content is equal to or less than 0.20 mass %.

[Preferable Range of Mg Content: Equal to or Less than 0.20 Mass %]

Mg has an effect of being solid-solutionized in the base metal and increasing the strength of an aluminum alloy sheet, and the effect thereof improves as Mg content increases. The thermal conductivity improves and the performance as a heat sink material improves when Mg content is equal to or less than 0.20 mass %.

[Preferable Range of Cr Content: Equal to or Less than 0.10 Mass %]

Cr has an effect of being solid-solutionized in the base metal and increasing the strength of an aluminum alloy sheet, and the effect thereof improves as Cr content increases. The thermal conductivity improves and the performance as a heat sink material improves when Cr content is equal to or less than 0.10 mass %.

[Preferable Range of Zn Content: Equal to or Less than 0.20 Mass %]

Zn has an effect of being solid-solutionized in the base metal and increasing the strength of an aluminum alloy sheet, and the effect thereof improves as Zn content increases. The thermal conductivity improves and the performance as a heat sink material improves when Zn content is equal to or less than 0.20 mass %.

[Preferable Range of Ti Content: Equal to or Less than 0.10 Mass %]

Ti has an effect of miniaturizing and homogenizing (stabilizing) the aluminum alloy casting microstructure, and has an effect of preventing the casting crack in blooming the slab for rolling. When Ti content exceeds 0.10 mass %, the effect thereof saturates. Also, when Ti content is equal to or less than 0.10 mass %, the thermal conductivity improves. Therefore, containment exceeding 0.10 mass % is unnecessary.

### [Thermal Conductivity]

With respect to the heat sink formed body 2, the heat radiation property is required because the application thereof is the heat sink 1. In order to secure the desired heat radiation property in the present invention, the thermal conductivity of the aluminum sheet forming the heat sink formed body 2 should be equal to or greater than 150 W/m·K, and preferably equal to or greater than 200 W/m·K. Further, although the upper limit value is not to be particularly stipulated, it is preferably equal to or less than 240 W/m·K from the economical viewpoint. As the aluminum alloy having such a property, the alloys with the predetermined series number and composition described above can be cited.

The thermal conductivity can be measured by the laser flash method, for example.

Also, the aluminum sheet used for the heat sink formed body 2 may be one without treatment, the pre-coated material or the after-coated material. Further, although the formed body 2 may be subjected to anodizing after working, the pre-coated material is preferable from the economical viewpoint.

### [Arithmetic Mean Roughness Ra]

The heat sink formed body 2 is manufactured by forming work of the aluminum sheet. As the method for forming work of the aluminum sheet, bending work, pressing work, drawing work, ironing work, and the like can be cited, however, when the onboard heat sink is manufactured on the base of a sheet, main working method becomes the bending work. By performing such forming work, the aluminum sheet with the initial flat plane shape is deformed cubically. At this time, the skin of the surface of the worked part deformed in the bending work in particular is roughened, the unevenness may be generated, and the crack may be generated. When such phenomenon occurs, the sheet thickness reduces locally, the cross-sectional area of the sheet reduces, the thermal conduction is impeded, and the heat radiation property deteriorates.

Also, when a film is formed on the surface described below, the film is broken, the base is exposed, and the merchantability from the standpoint of the appearance deteriorates.

As a result of studying such surface roughness of the worked part of the formed body as causing such deterioration of the heat radiation property, it was found out that, in order to suppress deterioration of the heat radiation property and to achieve a level permissible from the standpoint of the appearance also, the arithmetic mean roughness Ra of the roughened surface occurring in the worked part should be equal to or less than 1.5 μm. The arithmetic mean roughness Ra is preferably equal to or less than 1.0 μm, more preferably equal to or less than 0.8 μm, and still more preferably equal to or less than 0.7 μm. The lower limit value of the arithmetic mean roughness Ra of the surface of the worked part only has to be equal to or greater than 0.3 μm practically.

The arithmetic mean roughness Ra is measured using a surface roughness measuring instrument available in the market. For example, a surfcorder and the like can be used.

A test specimen is cut out from the worked part of the formed body, a probe of the surface roughness measuring instrument is scanned for the test specimen in the direction orthogonal to the rolling direction, and the roughness is measured as the arithmetic mean roughness (Ra) described in JIS B 0601.

### <Crystal Microstructure>

With respect to the aluminum sheet, it is preferable that the crystal microstructure is fibrous. “Fibrous” means a state of having the elongated microstructure whose aspect ratio of the long axis direction and the short axis direction of the crystal microstructure is equal to or greater than 10 times. When the crystal microstructure of the aluminum sheet is fibrous, the surface of the worked part of the formed body described above becomes smooth and the arithmetic mean roughness of the surface of the worked part becomes small, which is therefore preferable. Among the fibrous microstructure, one having the length of 5-50 μm in the short axis direction of the crystal microstructure has less surface roughening of the worked part, which is preferable. The aluminum sheet having coarse granular crystal microstructure normally has large arithmetic mean roughness of the surface of the worked part, which is not preferable.

The crystal microstructure of the aluminum sheet can be discriminated by a microscope. When the crystal microstructure is discriminated by the microscope, the cross section of the aluminum which becomes parallel to the direction the aluminum is extended by rolling (rolling direction) is observed.

Next, preferable annealing condition for achieving the fibrous microstructure will be explained.

It is preferable that the annealing condition for achieving the fibrous microstructure and providing excellent bending workability is 130-280° C. and 1-10 hours. When the annealing temperature is below 130° C., the property varies within the aluminum coil annealed. On the other hand, when the annealing temperature exceeds 280° C., restoration and recrystallization progress, the proof stress drops, and the crystal grains are coarsened. Also, when the annealing time is less than 1 hour, the property within the aluminum coil varies similarly to the case the temperature is low. On the other hand, when the annealing time exceeds 10 hours, the factory productivity deteriorates.

### <Film>

With respect to the aluminum sheet forming the heat sink formed body 2 of the present invention, the film 3 is formed on the surface thereof. Because the film 3 is formed on the surface of the heat sink formed body 2, the durability of the heat sink formed body 2 can be improved. Here, the surface means at least one face of the faces of the heat sink formed body 2, and so-called front face and back face are included.

Although the kind of the film 3 is not particularly limited, the resin-based film and inorganic film such as the pre-coated film, after-coated film, and anodizing film can be cited.

It is preferable that the film 3 is a thermosetting resin. The thermosetting resin can be obtained, for example, by that two kinds or more selected from a polyester resin, epoxy resin, phenolic resin, melamine resin, urea resin, and acrylic resin are included, and that a hydroxyl group, carboxyl group, glycidyl group, amino group, isocyanate group and the like included in the both resins are made to form a combination for mutual chemical bonding. When two kinds or more of the resins of such combination are included, because one resin and the other resin thermosettingly react with each other as a main agent and a setting agent, a thermosetting resin is formed. When the thermosetting reaction does not proceed sufficiently according to the combination, a setting agent such as an isocyanate compound may be combined separately.

When such resin is included alone (for example when a polyester resin is included alone), there is a case the film 3 is fused when the heat sink 1 is used. In this case, the adherence force of the heat sink 1 and an LED element 4 deteriorates, and therefore the durability of the heat sink 1 possibly deteriorates. However, even when the resin is used alone, by combination with a setting agent such as an isocyanate compound separately, a thermosetting resin having sufficient heat resistance and adhesion can be achieved.

Out of the combination of the films combining two kinds or more of the resin composition, for example, when an amino-cured polyester-system resin, isocyanate-cured polyester-system resin, melamine-cured polyester-system resin, phenol-cured epoxy-system resin, urea-cured epoxy-system resin, and the like are utilized, the heat resistance and adhesion improve, which is more preferable. Further, a modified resin such as an acrylic modified epoxy resin and a urethane modified polyester resin can be also suitably used.

It is preferable that the film 3 is black. The reason is that, when the color tone of the film 3 is black, the heat radiation property increases, and the heat radiation property as the heat sink 1 improves further. In order to make the film 3 black, it is preferable that the film 3 is made a resin-based film and the black pigment composition is contained. As the concrete examples of the black pigment composition, in addition to those of the carbon system such as the carbon black and graphite, the metal oxide system and the like of copper, manganese, iron and the like can be cited. It is preferable that the black pigment composition is added by 3-50 mass % to the resin material that forms the film. When the film 3 is an inorganic film, a black anodized film is preferable.

In the pre-coated aluminum sheet related to the first invention, it is preferable that the film thickness of the film 3 is 15-200 μm. When the film thickness is less than 15 μm, the cushion property of the film 3 deteriorates. On the other hand, when the film thickness exceeds 200 μm, because the heat resistance of the coating film increases excessively, the heat radiation property of the heat sink 1 deteriorates. However, because the improvement effect of the cushion property and the integrated emissivity saturates in the range 50-200 μm of the film thickness, it is preferable that the film thickness is 15-50 μm from the economical viewpoint.

With respect to the measuring method of the film thickness of the film 3, for example, measurement is possible by an eddy current film thickness meter ISOSCOPE®.

In the pre-coated aluminum sheet related to the second invention, because the film 3 is formed, the heat resistance in heat transmission increases, and therefore it is preferable that the film thickness of the film 3 is comparatively small. When the film thickness of the film 3 is less than 5 μm, excellent emissivity cannot be secured. On the other hand, even when the film thickness of the film 3 exceeds 15 μm, the emissivity does not improve any more, and the heat resistance of the film 3 increases adversely. Therefore, the film thickness of the film 3 is made 5-15 μm. The film thickness of the film 3 is more preferably 7-12 μm.

### [Arithmetic Mean Roughness (Ra)]

In the pre-coated aluminum sheet related to the second invention, the heat resistance is reduced as much as possible while the emissivity is maintained by setting the film thickness of the film 3 to thinner side as described above. However, when the film thickness of the film 3 is made thin, the emissivity lowers in general. Therefore, in order to compensate drop of the emissivity, the surface roughness of the film 3 is set to the larger side as described below. With the surface of the film 3 being roughened to some degree, the surface area increases, and the emissivity can be increased.

When the arithmetic mean roughness Ra of the surface of the film 3 is less than 0.5 μm, excellent emissivity is hardly secured. On the other hand, when the arithmetic mean roughness Ra of the surface of the film 3 exceeds 3 μm, the surface becomes excessively rough, fine voids are liable to be formed in a gap against the LED element 4, and the thermal conduction between the LED element 4 and the heat sink 1 is damaged. Therefore, the arithmetic mean roughness Ra of the surface of the film 3 is made 1-3 μm. The arithmetic mean roughness Ra of the surface of the film 3 is more preferably 1-3 μm, and still more preferably 1-2 μm.

In the pre-coated aluminum sheet related to the second invention, with respect to the method for adjusting the arithmetic mean roughness Ra of the surface of the film 3, the arithmetic mean roughness Ra can be adjusted by changing the method and degree of polishing the surface of the aluminum sheet before forming the film, roughening by shot blasting, or adding the aggregate to the film as described below, however, the method of adding the aggregate to the film is preferable.

The arithmetic mean roughness Ra is measured using a surface roughness measuring instrument available in the market. For example, a surfcorder and the like can be used.

A probe of the surface roughness measuring instrument is scanned for the test specimen in the direction orthogonal to the rolling direction, and the roughness is measured as the arithmetic mean roughness (Ra) described in JIS B 0601.

It is preferable that the film 3 is a thermosetting resin. The thermosetting resin can be obtained by that two kinds or more selected from a polyester resin, epoxy resin, phenolic resin, melamine resin, urea resin, and acrylic resin for example are included, and that a hydroxyl group, carboxyl group, glycidyl group, amino group, isocyanate group and the like included in the both resins are made to form a combination for mutual chemical bonding. When two kinds or more of the resins of such a combination are included, because one resin and the other resin thermosettingly react with each other as a main agent and a setting agent, a thermosetting resin is formed. When the thermosetting reaction does not proceed sufficiently according to the combination, a setting agent such as an isocyanate compound may be combined separately.

When such resin is included alone (for example when a polyester resin is included alone), there is a case the film 3 is fused when the heat sink 1 is used. In this case, the adherence force of the heat sink 1 and an LED element 4 deteriorates, and therefore the durability of the heat sink 1 possibly deteriorates. However, even when the resin is used alone, by combination with a setting agent such as an isocyanate compound separately, a thermosetting resin having sufficient heat resistance and adhesion can be achieved.

Out of the combination of the films combining two kinds or more of the resin composition, when an amino-cured polyester-system resin, isocyanate-cured polyester-system resin, melamine-cured polyester-system resin, phenol-cured epoxy-system resin, urea-cured epoxy-system resin, and the like for example are utilized, the heat resistance and adhesion improve which is more preferable. Further, a modified resin such as an acrylic modified epoxy resin and a urethane modified polyester resin can be also suitably used.

As described above, the black pigment composition is used for making the resin-based film black and improving the emissivity. As the concrete examples of the black pigment composition, in addition to those of the carbon system such as the carbon black and graphite, the metal oxide system and the like of copper, manganese, iron and the like can be cited. The black pigment composition is added by approximately 3-50 mass % to the resin material that forms the film.

The aggregate is used for controlling the arithmetic mean roughness Ra of the surface of the film 3 to the predetermined range described above. As the concrete examples of the aggregate, the organic system aggregate represented by cross-linking acrylic beads, cross-linking urethane beads, and the like, the inorganic system aggregate represented by glass beads and the like and so on can be cited. The aggregate with the average grain size of approximately 3-50 μm is preferably used. The aggregate is added by approximately 3-30 mass % to the resin material that forms the film according to the necessity.

### [Integrated Emissivity]

In the present invention, the integrated emissivity of the film 3 in the infrared region having the wavelength of 3-30 μm is equal to or greater than 0.80 at 25° C. The emissivity is a proportional factor obtained by dividing the infrared radioactivity from the object surface by the infrared radioactivity from the black body surface, and is defined with respect to the light with a predetermined wavelength in a predetermined temperature. The possible numerical value is within the range from 0 (white body) to 1 (black body), and, as the number is larger, the infrared radioactivity is larger. The result obtained by integrating it over the wavelength region of a certain range is the integrated emissivity. According to Planck's radiation formula, the wavelength of the infrared possibly generated at a temperature near the room temperature which is the implemented temperature of the present invention, or more specifically the actual use temperature range of 0-100° C., is concentrated to the range of 3-30 μm of the wavelength region. In other words, the infrared of the wavelength region deviating from the range of this wavelength region can be ignored. By such reason, in the present invention, limitation is made to the infrared of the wavelength region of 3-30 μm at 25° C.

When the integrated emissivity of the infrared having a wavelength of 3-30 μm with respect to the film 3 is less than 0.80 at 25° C., the capacity of emitting the heat as the infrared from the surface of the film 3 deteriorates, and the capacity of cooling the product becomes insufficient. Therefore, the heat radiation property of the heat sink 1 deteriorates. Also, the integrated emissivity in the infrared region having the wavelength of 3-30 μm described above is more preferably equal to or greater than 0.85, and still more preferably equal to or greater than 0.90. Further, although the upper limit value is not particularly stipulated, it is preferable to be equal to or less than 0.99 from the economical viewpoint. The integrated emissivity of the infrared having a wavelength of 3-30 μm can be controlled by combination of the color of the film, the film thickness, the surface state, the kind of film, and the like.

The integrated emissivity of the infrared having the wavelength of 3-30 μm with respect to the film 3 can be measured using a simplified emissivity meter available in the market, and can be measured using a Fourier transform infrared spectrophotometer (FTIR) and the like. For example, measurement is possible using the emissivity meter apparatus D&S AERD made by Kyoto Electronics Manufacturing Co., Ltd.

### [Others]

With respect to the film 3, a coloring agent of a small amount and additives imparting various functions can be contained within a range the desired effect of the present invention is exerted. For example, in order to further improve the formability, one kind or two kinds or more of lubricants such as the polyethylene wax, carnauba wax, micro crystalline wax, lanolin, Teflon® wax, silicone-based wax, graphite-based lubricant, and molybdenum-based lubricant for example can be contained. Also, as the electro-conductive fine particles to impart the electro-conductivity aiming to secure the earthing required in the electronic devices and the like, one kind or two kinds or more of metal fine particles to begin with nickel fine particles, metal oxide fine particles, electro-conductive carbon, graphite, and the like for example can be contained. Further, when the antifouling property is required, the fluorine-based compound and silicone-based compound may be contained. Other than them, the antibacterial agent, antimold agent, deodorant, antioxidant, ultraviolet absorbent, antirust pigment, extender pigment, and the like may be contained provided that the desired effect of the present invention is exerted.

### <<Aluminum Sheet>>

An aluminum sheet 20 used for the heat sink for onboard LED lighting of the present invention has the thermal conductivity equal to or greater than 150 W/m·K and the fibrous crystal microstructure. The thermal conductivity and the fibrous crystal microstructure are as described above.

When the crystal microstructure of the aluminum sheet 20 is fibrous, surface roughening in bending work becomes less. Here, in the case of the after-coated material, even when the surface is roughened, spraying can be performed so as to cover the coating film from over the sheet, therefore such limitation is unnecessary. However, in the case of the pre-coated material, when surface roughening of the raw material of the bent part is severe, the crack is possibly generated in the coating film. Therefore, it is preferable that the crystal microstructure of the aluminum sheet 20 is fibrous.

### <<Pre-Coated Aluminum Sheet>>

As shown in FIG. 1B, a pre-coated aluminum sheet 10 related to the first invention is used for a heat sink for onboard LED lighting, and includes the aluminum sheet 20 and a resin-based film 3A formed on the surface of the aluminum sheet 20. Also, the aluminum sheet 20 has the thermal conductivity equal to or greater than 150 W/m·K, and the crystal microstructure of the aluminum sheet 20 is fibrous. The resin-based film 3A includes a thermosetting resin and a black pigment composition, and the resin-based film 3A is characterized that the integrated emissivity in the infrared region having the wavelength of 3-30 μm is equal to or greater than 0.80 at 25° C.

Further, the pre-coated aluminum sheet 10 related to the second invention is used for a heat sink for onboard LED lighting, and includes the aluminum sheet 20 and the resin-based film 3A formed on the surface of the aluminum sheet 20. Also, it is characterized that the aluminum sheet 20 has the thermal conductivity equal to or greater than 150 W/m·K, the resin-based film 3A includes a thermosetting resin, a black pigment composition, and aggregate, the film thickness of the resin-based film 3A is 5-15 μm, the arithmetic mean roughness Ra of the surface of the resin-based film 3A is 1-3 μm, and the integrated emissivity of the resin-based film 3A in the infrared region having the wavelength of 3-30 μm is equal to or greater than 0.80 at 25° C.

It is preferable that the crystal microstructure of the aluminum sheet 20 that forms the pre-coated aluminum sheet 10 related to the second invention is fibrous. As described above, if the crystal microstructure of the aluminum sheet 20 is fibrous, when forming work is performed in order to manufacture the formed body, the surface roughening of the worked part of the formed body becomes less, and generation of the crack in the pre-coated film can be prevented.

The thermal conductivity, the fibrous crystal microstructure, the composition of the resin-based film 3A, and the integrated emissivity of the aluminum sheet 20 are as described above.

Although the embodiments of the present invention have been explained above, the present invention is not to be limited to the embodiments described above, and can be changed within a range not departing from the range of the present invention.

For example, a pretreatment film (illustration thereof is omitted) may be arranged by pretreatment on the surface of the aluminum sheet 20.

### <Pretreatment>

In order to improve the adhesion with the resin-based film 3A, it is preferable to subject the surface of the aluminum sheet 20 to pretreatment. With respect to preferable pretreatment, conventional known reaction type pretreatment film and spray type pretreatment film containing Cr, Zr, or Ti can be utilized. More specifically, the phosphoric acid chromate film, chromic acid chromate film, zirconium phosphate film, zirconium oxide film, titanium phosphate film, spray type chromate film, spray type zirconium film, and the like can be appropriately used. The pretreatment film of organic/inorganic hybrid type is also applicable in which an organic composition is combined to these films. Also, in recent years, hexavalent chromium tends to be hated in the trend of environmental responsiveness, and it is preferable to use the phosphoric acid chromate film, zirconium phosphate film, zirconium oxide film, titanium phosphate film, spray type zirconium film, and the like not containing hexavalent chromium.

Further, in the present invention, as the film thickness of the pretreatment film, the deposit of Cr, Zr, or Ti contained in the pretreatment film composition to the aluminum sheet 20 (metal Cr-, metal Zr-, or metal Ti-converted value) can be measured comparatively simply and quantitatively using conventional known fluorescent X-ray method. Therefore, the quality control of the pre-coated aluminum sheet 10 can be executed without impeding the productivity. Also, it is preferable that the deposit of the pretreatment film is 10-50 mg/m² in terms of the metal Cr-, metal Zr-, or metal Ti-converted value. When the deposit is equal to or greater than 10 mg/m², the entire surface of the aluminum sheet 20 can be coated uniformly, and the corrosion resistance improves. Also, when the deposit is equal to or less than 50 mg/m², the cracking is hardly generated in the film itself of the pretreatment in forming the pre-coated aluminum sheet 10.

Also, when the productivity is not considered, the surface of the aluminum sheet 20 can be subjected to conventional known treatment such as anodizing and electrolytic etching treatment. When these treatments are performed, because fine unevenness is formed on the surface of the aluminum sheet 20, the adhesion of the resin-based film 3A significantly improves.

Also, when the corrosion resistance is not required that much and it is intended to be done with a simple method, a method of subjecting the surface of the aluminum sheet 20 to degreasing treatment only is also acceptable. With respect to the method of degreasing, conventional known methods such as degreasing by organic system chemicals, degreasing by surfactant system chemicals, degreasing by alkaline system chemicals, and degreasing by acidic system chemicals can be employed. However, because the organic system chemicals and the surfactant system chemicals are inferior in the degreasing capacity a little bit, degreasing by alkaline system chemicals and acidic system chemicals is superior in the productivity. Although the degreasing capacity of the alkaline system chemicals can be controlled by the main composition, concentration, and treatment temperature of the alkali used, when the degreasing capacity is increased, smut is generated much, therefore, unless water washing thereafter is not performed sufficiently, there is also a case that the adhesion of the resin-based film 3A deteriorates adversely. Also, when a kind containing magnesium much as the additive element is used as the aluminum sheet 20, there is a case in the alkaline system chemicals that magnesium remains on the surface and the adhesion of the resin-based film 3A deteriorates. Therefore, in this case, it is preferable to use or jointly use the acidic system chemicals.

### <<Method for Manufacturing Pre-Coated Aluminum Sheet>>

Next, an example of the method for manufacturing the pre-coated aluminum sheet will be explained referring to FIG. 1 when it will be appropriate.

The method for manufacturing the pre-coated aluminum sheet 10 is not particularly limited, and the pre-coated aluminum sheet 10 can be obtained by spraying the coating material containing a resin that forms the base resin and the hardening agent on the aluminum sheet by conventional known method, and thereafter effecting the crosslinking reaction by heating. Also, it is preferable that the baking temperature in baking the coating material is made approximately 150° C. to 285° C.

Here, although the coating material can be sprayed by any means such as a brush, roll coater, curtain flow coater, roller curtain coater, electro-static coating machine, blade coater, and die coater, it is preferable to use the roll coater particularly in which the coating amount becomes uniform and the work is simple. When spraying is performed by the roll coater, the film thickness of the resin-based film 3A can be controlled by appropriately adjusting the convey speed of the aluminum sheet 20, the rotation direction and the rotation speed of the rolls, the pressing pressure (nip pressure) between the rolls, and the like.

When the heat sink 1 is to be manufactured using the pre-coated aluminum sheet 10, the pre-coated aluminum sheet 10 can be subjected to forming work such as bending work by a conventional known method, and can be formed into the shape of the heat sink 1.

### Examples

Next, the present invention will be explained specifically comparing the example satisfying the requirement of the present invention and the comparative example not satisfying the requirement of the present invention.

In the present embodiment, simulated heat sinks for onboard LED lighting obtained by folding work of aluminum alloy sheets with different thermal conductivity, sheet thickness and crystal microstructure were manufactured, and “continuous lighting test” for confirming the heat radiation performance was conducted.

First, the examples and the comparative examples of the first invention will be explained.

### (Test Nos. 1-14)

An aluminum alloy with the composition shown in Table 1 was molten and casted to obtain an ingot, the ingot was subjected to facing, and was thereafter subjected to homogenizing heat treatment at 480° C. This homogenized ingot was subjected to hot rolling, cold rolling, and annealing treatment, and a rolled sheet with 1.0 mm sheet thickness was obtained. A coating film was formed on the surface of this rolled sheet as explained below to obtain a test sample. The details will be given below.

Here, those with a fibrous microstructure excluding Nos. 7 and 8 were subjected to cold working with the working rate of 80% after intermediate annealing, and were thereafter subjected to finish annealing at 240° C. for 4 hours. Nos. 7 and 8 were subjected to cold working without performing intermediate annealing, and were thereafter subjected to finish annealing at 360° C. for 4 hours.

TABLE 1
Composition (mass %)

| | | | | | | | | |
|---|---|---|---|---|---|---|---|---|
| Si | Fe | Cu | Mn | Mg | Cr | Zn | Ti | Remainder |

Alloy with thermal conductivity of 230 W/m · K

| | | | | | | | | |
|---|---|---|---|---|---|---|---|---|
| 0.10 | 0.30 | 0.02 | 0.01 | 0.02 | 0.01 | 0.01 | 0.01 | Al and inevita- |
| | | | | | | | | ble impurities |

Alloy with thermal conductivity of 160 W/m · K

| | | | | | | | | |
|---|---|---|---|---|---|---|---|---|
| 0.25 | 0.45 | 0.20 | 1.10 | 1.20 | 0.02 | 0.20 | 0.03 | Al and inevita- |
| | | | | | | | | ble impurities |

Alloy with thermal conductivity of 120 W/m · K

| | | | | | | | | |
|---|---|---|---|---|---|---|---|---|
| 0.10 | 0.20 | 0.04 | 0.35 | 4.55 | 0.02 | 0.02 | 0.01 | Al and inevita- |
| | | | | | | | | ble impurities |

First, an LED lighting unit of 10 W available in the market was purchased and disassembled, and a heat sink made of a die-cast was taken out and was made a heat sink for the benchmark. Next, heat sinks made of an aluminum alloy sheet and becoming the example and the comparative example were manufactured simulating the shape of this heat sink for the benchmark. In simulating the shape, special attention was paid to truly reproduce at least the shapes of the LED element attaching part and the joining part that became necessary in reassembling into the LED lighting unit. The reason of doing so is that such a shape with which assembling into the lighting unit before disassembling is impossible has no usability. Also, a shape that could be shaped from one sheet was employed considering the productivity.

The heat sinks that became the example and the comparative example were manufactured as follows. First, the surface of the rolled sheet formed of the aluminum alloy having various sheet thickness, thermal conductivity, and crystal microstructure was subjected to phosphoric acid chromate treatment after weak alkaline degreasing. Next, first, on the face of one side, a coating material becoming the composition described in the table of the example after heating was sprayed by a bar coater so as to achieve the targeted thickness. Thereafter, temporary drying was performed at 100° C. for 60 s of the degree the crosslinking reaction was not promoted. Next, the coating material with the composition same with that for the first face was sprayed on the opposite face by the same bar coater. By being heated thereafter with the baking temperature of 230° C. of the raw material arrival temperature and 60 s of the retention time in the furnace, the pre-coated aluminum sheet was manufactured. Also, the size of this pre-coated aluminum sheet was made 30 cm×30 cm, and the one obtained by folding work of it into a shape generally same with that of the heat sink made of a die-cast described above was used as the heat sink of the test sample (Test Nos. 1-14). In attaching the base plate of the LED element to the heat sink, bolts and nuts of M3 were used for fastening. Also, on the joining face of the base plate of the LED element and the heat sink, silicone grease available in the market was sprayed in order to increase the degree of the contact.

### [Thermal Conductivity]

The thermal conductivity of the aluminum sheet was measured by the laser flash method.

### [Crystal Microstructure]

The crystal microstructure (fibrous, equi-axed) of the aluminum sheet was determined as follows. Here, the equi-axed microstructure expresses such microstructure whose aspect ratio of the long axis and the short axis is equal to or less than 3 times. After performing electrolytic etching in 5% tetrafluoroborate solution, the crystal microstructure was determined from the crystal microstructure image obtained by polarization microscope observation. The observed face is the surface of the sheet.

### [Arithmetic Mean Roughness Ra]

The arithmetic mean roughness (Ra) of the surface was measured using the surface roughness measuring instrument (Surfcorder SE-30D made by Kosaka Laboratory Ltd.). A probe was scanned for the test sample in the direction orthogonal to the rolling direction, and the arithmetic mean roughness (Ra) described in JIS B 0601 was measured.

### [Film Thickness of Film]

The film thickness of the film was measured using the eddy current film thickness meter ISOSCOPE®.

### [Integrated Emissivity]

The emissivity of the integrated emissivity in the infrared region having the wavelength of 3-30 μm was measured under the temperature condition of 25° C. using the emissivity meter apparatus D&S AERD made by Kyoto Electronics Manufacturing Co., Ltd. Also, because the measuring wavelength range of this simple emissivity meter is specified to be 3-30 μm, the numerical figure displayed becomes the integrated emissivity defined in the present invention.

Those with the integrated emissivity in the infrared region having the wavelength of 3-30 μm of equal to or greater than 0.80 at the temperature of 25° C. was determined to be excellent, and those of less than 0.80 was determined to be poor.

### [Heat Radiation Property: Continuous Lighting Test]

Although use of the onboard LED lighting in various environments in the world can be assumed, the lighting is actually used only in the night time. In such a condition, it is considered that the severest heat radiation property is required for the night time in the tropical zone. Therefore, assuming such an environment, the continuous lighting test was conducted under the environment of 35° C.

The LED element of 10 W was attached to each heat sink of the benchmark, example, and comparative example and was made to emit light, and the temperature of the heat sink right below the LED element when the temperature reached a steady state was measured. At this time, the case the temperature was equal to or below that of the benchmark was determined to be excellent in the heat radiation property (excellent), and the case the temperature reached higher than that of the benchmark was determined to be poor in the heat radiation property (poor).

### [Appearance]

The appearance of the worked part was determined by visual observation. Those smooth and excellent in appearance were determined to be excellent, and those with much unevenness and poor in appearance were determined to be poor.

### [Weight Reduction]

This time, in changing the material of the die-cast heat sink that became the benchmark to a sheet, the target of the weight reduction was made 50% of the benchmark apart from the performance. Therefore, the case the weight of the heat sink of the example or the comparative example manufactured for trial was equal to or less than 50% of the benchmark was determined to be light in weight (excellent), and the case of exceeding 50% was determined to be not particularly light in weight but to have no problem in use (fair).

The results of evaluation are shown in Table 2. Also, the underlined part in Table 2 expresses that the requirement or the effect of the first invention was not satisfied nor exhibited.

TABLE 2

| | Thermal | Crystal | Arithmetic | | | Film | | Inte- | Heat | | |
|---|---|---|---|---|---|---|---|---|---|---|---|
| | conduc- | micro- | mean rough- | Sheet | | thick- | | grated | radi- | Appear- | |
| | tivity | struc- | ness of | thick- | | ness | Color | emis- | ation | ance of | Weight |
| Test | of sheet | ture of | worked part | ness | | of film | of | sivity | prop- | worked | reduc- |
| No. | (W/m · K) | sheet | surface Ra (μm) | (mm) | Material of film | (μm) | film | of film | erty | part | tion |
| 1 | 120 | Fiber | 1.0 | 2 | Polyester•melamine | 15 | Black | 0.85 | Poor | Excellent | Excellent |
| 2 | 160 | Fiber | 0.8 | 2 | Polyester•melamine | 15 | Black | 0.85 | Excellent | Excellent | Excellent |
| 3 | 230 | Fiber | 1.2 | 2 | Polyester•melamine | 15 | Black | 0.85 | Excellent | Excellent | Excellent |
| 4 | 120 | Fiber | 1.0 | 3 | Polyester•melamine | 15 | Black | 0.85 | Poor | Excellent | Fair |
| 5 | 160 | Fiber | 0.9 | 3 | Polyester•melamine | 15 | Black | 0.85 | Excellent | Excellent | Fair |
| 6 | 230 | Fiber | 1.4 | 3 | Polyester•melamine | 15 | Black | 0.85 | Excellent | Excellent | Fair |
| 7 | 160 | Equi-axed | 1.7 | 2 | Polyester•melamine | 15 | Black | 0.85 | Poor | Poor | Excellent |
| 8 | 230 | Equi-axed | 2.0 | 2 | Polyester•melamine | 15 | Black | 0.85 | Excellent | Poor | Excellent |
| 9 | 160 | Fiber | 0.8 | 2 | Polyester•urea | 15 | Black | 0.85 | Excellent | Excellent | Excellent |
| 10 | 180 | Fiber | 0.8 | 2 | Polyester•melamine•epoxy | 15 | Black | 0.85 | Excellent | Excellent | Excellent |
| 11 | 160 | Fiber | 0.8 | 2 | Polyester•melamine•phenol | 15 | Black | 0.85 | Excellent | Excellent | Excellent |
| 12 | 160 | Fiber | 0.8 | 2 | Epoxy•phenol | 15 | Black | 0.85 | Excellent | Excellent | Excellent |
| 13 | 160 | Fiber | 0.8 | 2 | Polyester•epoxy•acrylic | 15 | Black | 0.85 | Excellent | Excellent | Excellent |
| 14 | 160 | Fiber | 0.8 | 2 | Polyester•melamine | 50 | Black | 0.9 | Excellent | Excellent | Excellent |

As shown in Table 2, in Test Nos. 2, 3, 5, 6, and 9-14, because the configuration of the first invention was satisfied, excellent result was secured. On the other hand, in Test Nos. 1, 4, 7, and 8, because the configuration of the first invention was not satisfied, the result became as follows.

In Test No. 1, because the thermal conductivity was less than the lower limit value, the heat radiation property was poor.

In Test No. 4, because the thermal conductivity was less than the lower limit value, the heat radiation property was poor.

In Test No. 7, because the crystal microstructure was equi-axed, the appearance and the surface roughness of the worked part were poor, and the heat radiation property was also poor.

In Test No. 8, because the crystal microstructure was equi-axed, the appearance and the surface roughness of the worked part were poor.

Next, the examples and the comparative examples of the second invention will be explained. A lot of the contents are common to the explanation of the examples and the comparative examples of the first invention described above. Therefore, only the portions different from the examples and the comparative examples of the first invention will be explained below.

### (Test Nos. 15-39)

An aluminum alloy with the composition shown in Table 1 was molten and casted to obtain an ingot, the ingot was subjected to facing, and was thereafter subjected to homogenizing heat treatment at 480° C. This homogenized ingot was subjected to hot rolling, cold rolling, and annealing treatment, and a rolled sheet with 1.0 mm sheet thickness was obtained. The rolling rate in the cold rolling was made 75%, and the annealing treatment was performed at 240° C. for 4 hours. However, with respect to only the example of No. 39 shown in Table 3, the annealing treatment was performed at 360° C. for 4 hours. A coating film was formed on the surface of this rolled sheet to obtain a test sample. The operation thereafter and the evaluation method are similar to those of the case of the first invention.

The surface roughness was adjusted in the second invention by a method of adding the aggregate with different grain sizes while adjusting the adding amount. Although cross-linking acrylic beads were used for the aggregate, other resins and inorganic one are also applicable. Also, with respect to one with the anodizing treatment among the examples and the comparative examples, an aluminum sheet without any surface treatment was subjected to polishing or shot blasting first to adjust the surface roughness, was thereafter folded into a predetermined shape, and was thereafter subjected to sulfuric acid anodizing. The sulfuric acid was made 15%, and the voltage, current density, and exciting time were appropriately set to a condition with which a predetermined film thickness could be obtained. With respect to black anodizing in particular, after coloring by a black dye, sealing of anodic oxide coating was performed.

In the heat radiation property: continuous lighting test in the second invention, the evaluation method was as follows.

The LED element of 10 W was attached to each heat sink of the benchmark, example, and comparative example and was made to emit light, and the temperature of the heat sink right below the LED element when the temperature reached a steady state was measured. At this time, the case the temperature was equal to or below that of the benchmark was determined to be excellent in the heat radiation property, and the case the temperature reached higher than that of the benchmark was determined to be poor in the heat radiation property (poor). Among those the heat radiation property was excellent, one in which the temperature of the heat sink dropped from the temperature of the bench mark by equal to or more than 1° C. was determined to be excellent, and one in which the temperature of the heat sink dropped from the temperature of the bench mark by less than 1° C. was determined to be fair. Further, in the second invention, one in which the heat radiation property was excellent was recognized to correspond to the example, and one in which the heat radiation property was fair or poor was recognized to correspond to the comparative example.

Also, with respect to evaluation of the appearance in the second invention, the evaluation method is as follows.

The appearance of the worked part subjected to folding work was evaluated. The appearance of the worked part was determined by visual observation. Those smooth and excellent in appearance were determined to be excellent, and those with much unevenness in appearance were determined to be fair.

The contents of the examples and the comparative examples of the second invention and the results of evaluation thereof were shown in Table 3. Also, the underlined part in Table 3 expresses that the requirement or the effect of the second invention was not satisfied nor exhibited.

TABLE 3

| | Thermal | | | | Film | | Inte- | | Heat | | |
|---|---|---|---|---|---|---|---|---|---|---|---|
| | conduc- | Sheet | | Arithmetic | thick- | | grated | Crystal | radi- | | Appear- |
| | tivity | thick- | | mean rough- | ness | Color | emis- | micro- | ation | Weight | ance of |
| Test | of sheet | ness | | ness Ra | of film | of | sivity | structure | prop- | reduc- | worked |
| No. | (W/m · K) | (mm) | Material of film | (μm) | (μm) | film | of film | of sheet | erty | tion | part |
| 15 | 120 | 2 | Polyester•melamine | 0.5 | 15 | Black | 0.85 | Fiber | Poor | Excellent | Excellent |
| 16 | 160 | 2 | Polyester•melamine | 0.5 | 15 | Black | 0.85 | Fiber | Excellent | Excellent | Excellent |
| 17 | 230 | 2 | Polyester•melamine | 0.5 | 15 | Black | 0.85 | Fiber | Excellent | Excellent | Excellent |
| 18 | 120 | 3 | Polyester•melamine | 0.5 | 15 | Black | 0.85 | Fiber | Fair | Fair | Excellent |
| 19 | 160 | 3 | Polyester•melamine | 0.5 | 15 | Black | 0.85 | Fiber | Excellent | Fair | Excellent |
| 20 | 230 | 3 | Polyester•melamine | 0.5 | 15 | Black | 0.85 | Fiber | Excellent | Fair | Excellent |
| 21 | 160 | 2 | White anodic oxide | 0.5 | 5 | White | 0.55 | Fiber | Poor | Excellent | Excellent |
| 22 | 160 | 2 | Black anodic oxide | 0.5 | 20 | Black | 0.85 | Fiber | Fair | Excellent | Excellent |
| 23 | 160 | 2 | White anodic oxide | 0.5 | 15 | White | 0.75 | Fiber | Fair | Excellent | Excellent |
| 24 | 160 | 2 | Black anodic oxide | 0.5 | 15 | Black | 0.83 | Fiber | Excellent | Excellent | Excellent |
| 25 | 160 | 2 | Black anodic oxide | 0.1 | 15 | Black | 0.80 | Fiber | Fair | Excellent | Excellent |
| 26 | 160 | 2 | Black anodic oxide | 3.5 | 15 | Black | 0.88 | Fiber | Fair | Excellent | Excellent |
| 27 | 160 | 2 | Polyester•melamine | 0.5 | 5 | Black | 0.65 | Fiber | Poor | Excellent | Excellent |
| 28 | 160 | 2 | Polyester•melamine | 3 | 5 | Black | 0.87 | Fiber | Excellent | Excellent | Excellent |
| 29 | 160 | 2 | Polyester•melamine | 3.5 | 15 | Black | 0.88 | Fiber | Fair | Excellent | Excellent |
| 30 | 160 | 2 | Polyester•urea | 1 | 15 | Black | 0.85 | Fiber | Excellent | Excellent | Excellent |
| 31 | 160 | 2 | Polyester•melamine•epoxy | 1 | 15 | Black | 0.85 | Fiber | Excellent | Excellent | Excellent |
| 32 | 160 | 2 | Polyester•melamine•phenol | 1 | 15 | Black | 0.85 | Fiber | Excellent | Excellent | Excellent |
| 33 | 160 | 2 | Epoxy•phenol | 0.5 | 15 | Black | 0.85 | Fiber | Excellent | Excellent | Excellent |
| 34 | 160 | 2 | Polyester•epoxy•acrylic | 0.5 | 15 | Black | 0.85 | Fiber | Excellent | Excellent | Excellent |
| 35 | 160 | 2 | Polyester•melamine | 0.5 | 20 | Black | 0.90 | Fiber | Fair | Excellent | Excellent |
| 36 | 160 | 2 | Polyester•melamine | 1.5 | 300 | Black | 0.90 | Fiber | Poor | Excellent | Excellent |
| 37 | 160 | 2 | Polyester•melamine | 0.5 | 15 | Black | 0.80 | Fiber | Poor | Excellent | Excellent |
| 38 | 160 | 2 | Polyester only | 0.5 | 15 | White | 0.75 | Fiber | Poor | Excellent | Excellent |
| | | | | | | | | | (fused) | | |
| 39 | 230 | 2 | Polyester•melamine | 0.5 | 15 | Black | 0.85 | Equi-axed | Excellent | Excellent | Fair |

As shown in Table 3, Test Nos. 16, 17, 19, 20, 24, 28, 30-34, and 39 satisfied the configuration of the second invention, and exhibited excellent performance in the heat radiation property. However, the Test No. 39 had the equi-axed crystal microstructure of the sheet, and was slightly inferior in the appearance of the worked part compared to the sheet having the fibrous crystal microstructure. On the other hand, Test Nos. 15, 18, 21-23, 25-27, 29, and 35-38 did not satisfy the configuration of the second invention, and the result became as follows.

In Test No. 15, because the thermal conductivity was less than the lower limit value, the heat radiation property was poor.

In Test No. 18, because the thermal conductivity was less than the lower limit value, the heat radiation property was poor.

In Test Nos. 21 and 23, because the film was white, the integrated emissivity of the film in the infrared region became less than 0.80, and the heat radiation property was poor.

In Test Nos. 22 and 35, the film thickness of the film exceeded 15 μm, and the heat radiation property was slightly poor.

In Test No. 25, the arithmetic mean roughness of the surface of the film was less than 0.5 μm, and the heat radiation property was slightly poor.

In Test No. 26, the arithmetic mean roughness of the surface of the film exceeded 3 μm, and the heat radiation property was slightly poor.

In Test No. 27, the integrated emissivity of the film in the infrared region was less than 0.80, and the heat radiation property was poor.

In Test No. 29, the arithmetic mean roughness of the surface of the film exceeded 3 μm similarly to Test No. 26, and the heat radiation property was slightly poor.

In Test No. 36, the film thickness of the film exceeded 15 μm by far, and the heat radiation property was poor.

In Test No. 37, because the film had no color, the integrated emissivity of the film in the infrared region became less than 0.80, and the heat radiation property was poor.

In Test No. 38, the integrated emissivity of the film in the infrared region became less than 0.80 because the film was white, the film was formed of a polyester resin only, the heat resistance of the film was poor, and the film fused during the test for the heat radiation property.

Further, all of the LED heat sinks described in Patent Literatures 1-4 are the inventions in which the shape having the fins is indispensable or recommendable, the die cast method is the must in order to achieve these shapes with aluminum, and they correspond to the benchmark heat sink in the present invention. The alloy for casting used for the die cast method is basically low in thermal conductivity and hard to reduce the weight, and therefore does not satisfy the present invention. Also, there is no description on the surface which is the feature of the present invention in all of the heat sinks. As shown in the present embodiment, this aluminum sheet of the prior art does not satisfy a constant level in the evaluation described above. Therefore, it was clarified objectively by the present example that the aluminum sheet related to the present invention was superior compared to the aluminum sheet of the prior art.

Although the present invention has been explained in detail above illustrating the embodiments and examples, the purport of the present invention is not limited to the contents described above, and the range of the right thereof should be interpreted based on the description of the claims. Also, it is needless to mention that the contents of the present invention can be amended, changed, and so on based on the description described above.

The present application is based on the Japanese Patent Application (No. 2013-073265) applied on Mar. 29, 2013 and the Japanese Patent Application (No. 2013-073267) applied on Mar. 29, 2013, and the contents thereof are incorporated by reference into the present application.

### INDUSTRIAL APPLICABILITY

The present invention is useful for a heat sink for onboard LED Lighting.

### REFERENCE SIGNS LIST

1: Heat sink for onboard LED Lighting
2: Heat sink formed body
3: Film
3A: Resin-based film
4: LED element
10: Pre-coated aluminum sheet
20: Aluminum sheet
100: Onboard LED lighting

1: A pre-coated aluminum sheet, comprising:
an aluminum sheet; and
a resin-based film,
wherein
the aluminum sheet has a thermal conductivity of equal to or greater than 150 W/m·K,
the aluminum sheet has a fibrous crystal microstructure,
the resin-based film comprises a thermosetting resin and a black pigment composition, and
the resin-based film has an integrated emissivity in an infrared region having a wavelength of 3-30 μm of equal to or greater than 0.80 at 25° C.

2: A pre-coated aluminum sheet, comprising:
an aluminum sheet; and
a resin-based film, wherein
the aluminum sheet has a thermal conductivity of equal to or greater than 150 W/m·K,
the resin-based film comprises a thermosetting resin, a black pigment composition, and aggregate,
the resin-based film has a film thickness of 5-15 μm,
an arithmetic mean roughness Ra of a surface of the resin-based film is 1-3 μm, and
the resin-based film has an integrated emissivity in an infrared region having a wavelength of 3-30 μm of equal to or greater than 0.80 at 25° C.

3: The pre-coated aluminum sheet according to claim 2, wherein
the aluminum sheet has a fibrous crystal microstructure.

4: An aluminum sheet, having
a thermal conductivity of equal to or greater than 150 W/m·K, and
a fibrous crystal microstructure.

5: A heat sink, comprising a formed body formed of wrought aluminum and aluminum alloy sheets,
wherein
the wrought aluminum and the aluminum alloy sheets have a thermal conductivity of equal to or greater than 150 W/m·K, and
a surface of a worked part of the formed body has an arithmetic mean roughness Ra of equal to or less than 1.5 μm.

6: The heat sink according to claim 5, wherein
the wrought aluminum and aluminum alloy sheets have a fibrous crystal microstructure.

7: The heat sink according to claim 5, wherein
the formed body comprises a surface comprising a black film, and
an integrated emissivity of the film in an infrared region having a wavelength of 3-30 μm is equal to or greater than 0.80 at 25° C.

8: The heat sink according to claim 7, wherein
the film is a resin-based film comprising a thermosetting resin and a black pigment composition.

9: A heat sink, comprising:
a heat sink formed body formed of wrought aluminum and aluminum alloy sheets; and
a black film formed on a surface of the heat sink formed body, wherein
the wrought aluminum and aluminum alloy sheets have a thermal conductivity of equal to or greater than 150 W/m·K,
of the film has a film thickness of 5-15 μm,
a surface of the film has an arithmetic mean roughness Ra of 0.5-3 μm, and
the film has an integrated emissivity in an infrared region having a wavelength of 3-30 μm of equal to or greater than 0.80 at 25° C.

10: The heat sink according to claim 9, wherein
the film is a resin-based film comprising a thermosetting resin, a black pigment composition, and aggregate, and
the arithmetic mean roughness Ra of the surface of the film is 1-3 μm.

11: The heat sink according to claim 6, wherein
the formed body comprises a surface comprising a black film, and
an integrated emissivity of the film in an infrared region having a wavelength of 3-30 μm is equal to or greater than 0.80 at 25° C.
